(19) United States
(12) Patent Application Publication
(10) Pub. No.: US 2015/0051521 A1
(43) Pub. Date: Feb. 19, 2015

(54) CARDIOPULMONARY RESUSCITATION APPARATUS COMPRISING A PHYSIOLOGICAL SENSOR

(71) Applicant: KONINKLIJKE PHILIPS N.V., EINDHOVEN (NL)

(72) Inventors: Pierre Hermanus Woerlee, Valkenswaard (NL); Paul Aelen Philips, Eindhoven (NL); Haris Duric, Bothell, WA (US); Ihor Olehovych Kirenko, Eindhoven (NL)

(21) Appl. No.: 14/378,174

(22) PCT Filed: Mar. 7, 2013
(86) PCT No.: PCT/IB2013/051799

§ 371 Date: Aug. 12, 2014

Related U.S. Application Data
(60) Provisional application No. 61/610,013, filed on Mar. 13, 2012.

(51) Int. Cl. A61H 31/00

(52) U.S. Cl. CPC A61H 31/005; A61H 2201/5058
USPC 601/41

(57) ABSTRACT

The invention proposes aphysiological sensor for use with a Cardio Pulmonary Resuscitation (CPR) apparatus, the sensor comprising at least one camera element, adapted to detect a physiological signal, at least one illumination element, adapted to illuminate an area of a patient's body, a housing, adapted to receive the at least one camera element and the at least one illumination element, the housing comprising a fixation element for the fixation of the sensor either on an automated CPR apparatus or on the patient's body, and an automated Cardio Pulmonary Resuscitation apparatus comprising a physiological sensor.

### FIELD OF THE INVENTION

The invention relates to the field of cardiopulmonary resuscitation, and more specifically to optimizing blood flow during administering cardiopulmonary resuscitation. The invention addresses a physiological sensor and a cardiopulmonary resuscitation apparatus comprising a physiological sensor.

### BACKGROUND OF THE INVENTION

Cardiopulmonary resuscitation (CPR) is a well-known technique for increasing the chance for survival from cardiac arrest. However, it is very difficult to perform manual cardiopulmonary resuscitation with consistent high quality. Since CPR quality is key for survival there is a strong drive to have a mechanical automated device to replace less reliable and long duration manual chest compressions. Automated CPR (A-CPR) apparatuses were introduced in the market recently.

Present A-CPR systems, such as the systems describes in the patent publications U.S. Pat. No. 6,171,267, US 20040230140A1, U.S. Pat. No. 6,066,106A, apply standard compressions to the patient. It is obvious that tailoring the chest compressions to the patient is beneficial. For instance end-tidal CO2 can be used to optimize CPR for pulmonary circulation.

Optimizing brain flow during CPR will likely have a big impact on the outcome of cardiac arrest treatment. Furthermore brain perfusion related feedback would offer the opportunity to optimize the CPR procedure for the specific victim. This is a very valuable option and a key step for so-called personalized CPR. U.S. Pat. No. 7,190,999 describes an apparatus for assisting a rescuer in performing manual CPR on a victim. The apparatus comprises a SpO2 sensor for measuring blood oxygenation. A prompting device audibly conveys one or more actions that the rescuer should perform to improve the manual CPR.

During cardiac arrest, blood flow to the non-vital organs is strongly reduced by vaso-constriction. Blood flow to the brain is not constrained; therefore measurement of blood flow or blood volume in arteries connected to the arteries responsible for brain perfusion is desirable. Flow in such arteries can in principle be monitored with ultra sound, bioimpedance or photo plethysmography (PPG) techniques. Such techniques are either expensive or very prone to motion artifacts due to the chest compressions. It is also extremely difficult to remove these artifacts from the desired signal. A further drawback of such techniques is that the locations of high flow vary from patient to patient

Remote Photo-Plethysmographic (PPG) is a method to measure skin color variations using a camera, which is described in Wim Verkruysse, Lars O. Svaasand, and J. Stuart Nelson, “Remote plethysmographic imaging using ambient light”, Optics Express, Vol. 16, No. 26, December 2008. The method is based on the principle that temporal variations in blood volume in the skin lead to variations in light absorptions by the skin. Such variations can be registered by a video camera that takes images of a skin area, e.g. the face, while processing calculates a pixel average signal over a manually or automatically selected region (typically part of the forehead in this system). By looking at periodic variations of this average signal, physiological parameters such as the heart beat rate and respiratory rate can be extracted.

Photoplethysmography is a method for characterizing certain periodic physiological phenomena using skin reflectance variations. The human skin can be modeled as an object with at least two layers, one of those being the epidermis (a thin surface layer) and the other the dermis (a thicker layer underneath the epidermis). Approximately 5% of an incoming ray of light is reflected in the epidermis, which is the case for all wavelengths and skin colors. The remaining light is scattered and absorbed within the two skin layers in a phenomenon known as body reflectance (described in the Dichromatic Reflection Model).

The epidermis behaves like an optical filter, mainly absorbing light. The light is transmitted depending on its wavelength and the melanin concentration in the epidermis. In the dermis, light is both scattered and absorbed. The absorption is dependent on the blood composition, i.e. the content of blood and its ingredients such as haemoglobin, bilirubin, and beta-carotene, so that the absorption is sensitive to blood flow variations. The optical properties of the dermis are generally the same for all human races. The dermis contains a dense network of blood vessels, about 10% of an adult's total vessel network. These vessels contract according of the blood flow in the body. They consequently change the structures of the dermis, which influences the reflectance of the skin layers. Consequently, the heart rate can be determined from skin reflectance variations.

However non invasive techniques to monitor blood flow to the brain are lacking or are prone to severe motion artifacts.

### SUMMARY OF THE INVENTION

It would be desirable to achieve a cardiopulmonary resuscitation apparatus that takes into consideration the physical properties and the current health state of the patient. It would also be desirable to enable an automated cardiopulmonary resuscitation apparatus to find an efficient, yet safe mode of operation in a largely automated manner.

To better address one or more of these concerns, in a first aspect of the invention, a physiological sensor for use with a Cardio Pulmonary Resuscitation (CPR) apparatus, the sensor comprising at least one camera element, adapted to measure a physiological signal, at least one illumination element, adapted to illuminate an area of a patient's body, a housing, adapted to receive the at least one camera element and the at least one illumination element, the housing comprising a fixation element for the fixation of the sensor either on an automated CPR apparatus or on the patient's body.

By providing a fixation element for the fixation of the sensor, a small, portable sensor can be used, either to be mounted directly on an automated CPR device or to be placed as closely as possible to the area of interest of the patient's body. The physiological signal may be the blood flow, and PPG signals may be measured.

More than one camera element can be used, in order to improve signal to noise. The use of more than one camera element allows determining a common mode signal relating to the blood flow changes.

By providing a fixation element in a form of a suction cup type element adapted to be placed on a patient's body, the physiological sensor can be placed in sufficiently close proximity of the arteries that need to be monitored, yet far enough to monitor a complete area of interest. A suction cup element further allows for a firm fixation of the sensor which does not shift after fixing.

In another aspect of the present disclosure, the fixation element may comprise a goggle type element adapted to be placed on a patient's body. Apart from the firm fixation, the goggle type or spectacle type element, similar to a ski goggle, allows the use of the nose of the patient to be used for the alignment of the camera element.

In yet another aspect of the present disclosure, the fixation element may comprise a band fixation type element adapted to be placed on a patient's body.

In a further aspect, a shielding element may be provided for shielding from external light, in order to improve the signal to noise ratio.

The camera element may be self-aligned after placement. The camera element may also automatically search for locations where relevant PPG signals are located.

The camera element being one of at least one of a monochrome, color or infra red camera element. Color signals may help reducing motion artifact signals.

The camera element may be adapted to select an optimum location for the detection of the physiological signal. In particular, the camera element may be adapted automatically segment area of the patient body, based on amplitude of the detected physiological signal and is further adapted to select a region with a strongest detected physiological signal. This helps optimizing quality of the measurements, either by using optimum signals or by optimizing the signal to noise ratio.

Preferably, an output element is provided for supplying measured values of the physiological signal to a controller adapted to determine optimized operating parameters for the CPR.

The present invention also proposes an automated Cardio Pulmonary Resuscitation apparatus, comprising at least one sensor comprising at least one camera element, adapted to measure a physiological signal, at least one illumination element, adapted to illuminate an area of a patient's body, a housing, adapted to receive the at least one camera element and the at least one illumination element, the housing comprising a fixation element for the fixation of the sensor either on an automated CPR apparatus or on the patient's body, supplying measured values of a physiological signal related to blood flow; and a controller, receiving the measured values from the at least one sensor, the controller being adapted to determine optimized operating parameters for the CPR.

By providing a physiological sensor of the type described above to an automated CPR apparatus, monitoring of the PPG signals, and therefore monitoring of blood volume changes as a surrogate marker for the blood flow, can be achieved during resuscitation. Advantageously, a control loop may be formed, where measured signals may be used as feedback signals to optimize the compression. Compression parameters may be the compression depth, the compression/decompression frequency and the duty cycle. The amplitude of the PPG signals may be maximized. The automated CPR apparatus may therefore be adapted to determine how the compression parameters should be changed.

In one aspect of the disclosure, an indication element to indicate to a rescuer modifications to operating parameters related to the compression. The indication element may be a prompting device or a display.

In a further aspect of the disclosure, the automated CPR comprises a chest compression actuator, and an actuator driver that supplies drive signals to the chest compression actuator in dependence of operating parameters of the actuator driver, the operating parameters being received from the controller. The actuator driver receives the signal form the controller.

Accordingly, the invention proposes the use of a camera element for measuring PPG signals, to provide a feedback to either an automated cardiopulmonary resuscitation apparatus or a rescuer performing a cardiopulmonary resuscitation apparatus. The feedback is based on a physiological parameter that is related to blood flow and thus the very goal of most cardiopulmonary resuscitations.

These and other aspects of the invention will be apparent from and elucidated with reference to the embodiment(s) described herein after, given as examples only.

### BRIEF DESCRIPTION OF THE DRAWINGS

FIG. 1 shows a schematic block diagram of a sensor apparatus according to a first aspect of the invention.

FIG. 2 shows a sensor apparatus with an automated CPR device in one aspect of the invention.

FIG. 3 shows a PGP camera in yet another aspect of the invention.

FIG. 4 shows an automated cardio pulmonary resuscitation apparatus in one aspect of the invention

### DETAILED DESCRIPTION OF THE EMBODIMENTS

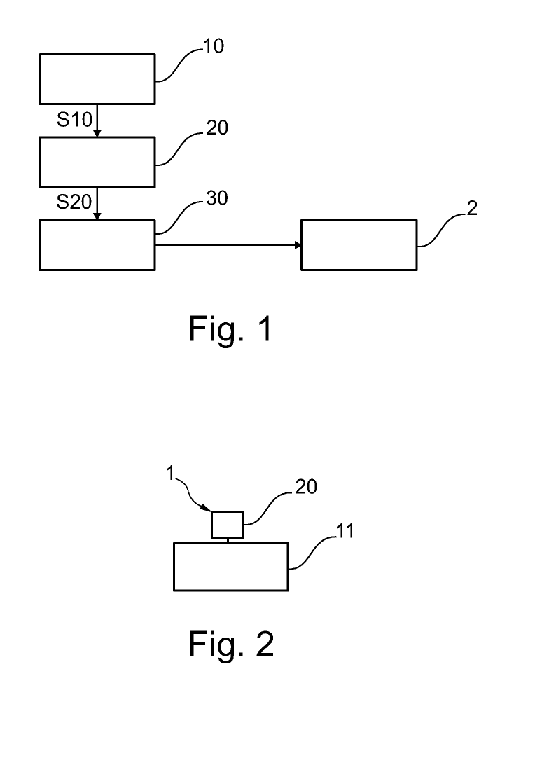

FIG. 1 shows a schematic block diagram of a sensor apparatus for an automated cardio pulmonary resuscitation apparatus according to a first aspect of the invention.

The sensor apparatus 1 can be used with an automated CPR device 2. The sensor apparatus 1 comprises a camera element 10 adapted to detect PPG signals S10. The camera element 10 may be used to determine variations in skin color or temperature on or near the body surface on selected areas of the body. One preferred area to be monitored is the face, where relevant PGP signals S10 representative of the blood flow to the brain may be sensed. Among others, measurement of blood flow or blood volume in arteries connected to the arteries responsible for brain perfusion is desirable. Some of these arteries are located in the facial area. Relevant arteries connected to the internal carotid artery are the supratrochlear artery, supraorbital artery, dorsal nasal artery, . . . ), arteries around the nose nostrils and possibly the ears.

The camera element 10 may work in different wavelength conditions, for example as a monochrome camera element, color camera element or Infra Red (IR) camera element.

The camera element 10 is connected to a normalization unit 20, which is adapted to normalize the detected PGP signals to reference signals, leading to exploitable sensor signals S20 as feedback signals sent to a controller 30.

The feedback signals may be used to ascertain the quality of the CPR whose goal is to improve blood perfusion of the patient or at least of the patient's vital organs. The degree and the quality of blood perfusion depends on the way the cardio pulmonary resuscitation is performed. Parameters of the cardio pulmonary resuscitation such as compression depth, compression rate, waveform, duty cycle, compression velocity and the like may have an influence on the blood perfusion. The feedback signals may be used to optimize the flow, which can be optimized by changing compression parameters like compression depth, frequency and duty cycle.

The compression parameters may be changed by a rescuer, assisted by the controller adapted to give advices of what parameters to change. In automatic way, the controller is adapted to send control signals to the automatic CPR device 2.

The automatic CPR device 2 may comprise a chest compression actuator adapted to perform compression/decompression cycles on a patient chest.

The person skilled in the art will therefore understand that either the chest compression actuator or the rescuer performing the compressions, the chest of the patient, the sensor apparatus 1 with the controller 30 form a loop control system that assures a good tracking of the CPR quality.

In one aspect of the invention, the rescuer can judge the signal and adopt CPR parameters if required.

In another aspect of the invention, the chest compression actuator or the rescuer performing the compressions, the chest of the patient, the sensor apparatus 1 with the controller 30 form a closed loop control system, whereby the closed loop control system may be adapted to modify the control signals for the compressions, based on the comparison between the desired PGP signal levels and the feedback signals.

To provide the robustness to motion and illumination changes, the sensor apparatus 1 might apply a combined analysis of at least two color channels, which might correspond to a visible light (e.g., red, green, blue), or invisible infra-red light.

The sensor apparatus 1 can be used to analyze the strength of detected heartbeat signal by estimating the pulsatility of the detected periodic signal. Since the spatial distribution of pulsatility of the measured signal is not equal, the camera element 10 is able to segment spatial skin areas with larger and lower pulsatility of the detected heartbeat signal. The person skilled in the art understands that measurements from spatial segments with higher pulsatility would provide a heartbeat signal with higher SNR, those more robust to motion or illumination changes.

Hence, the camera element 10 can measure on a much larger area than conventional PGP techniques. This reduces the small shifts.

The sensor apparatus 1 is adapted to automatically segment skin areas based on amplitude of the extracted periodic signal and select a region of interest with the strongest pulsatility, preferably at the beginning of measurements.

Hence, the sensor apparatus 1 is smart in the way that it can select the optimum location of the face with respect to the maximum PPG signal or maximum signal to noise ratio.

In another aspect of the invention, the sensor apparatus 1 can combine the analysis of spatial distribution of signal pulsatility with the analysis of other visible static features of the skin area, e.g. texture and uniformity of skin, amount of specular reflectance, etc.

FIG. 2 shows said sensor apparatus 1 with an automated CPR device 11.

As illustrated on FIG. 2, the sensor apparatus 1 is mounted on the CPR device 11, which can be positioned on the patient chest. The camera element 20 is pivotally mounted on an upper wall of the CPR device 11. The camera element 20 may be arranged to have its view area directed to the face of the patient when the CPR device is positioned in operative conditions.

The camera element 20 may comprise automatic detection means, to search automatically for the locations where relevant PPG signals are present. The relevant locations relates to locations where blood flow to the brain is not constrained, such as the arteries located in the facial area, such as the eyes, the ears or the nose.

The PPG signals detected, once normalized by the normalization unit are fed to the controller 30. The controller 30 is adapted to send control signals to the automatic CPR device 11, in order to modify, when needed, the compression parameters.

One issue with the sensor apparatus of FIG. 2 relates to the relative positioning of the camera element with respect to the patient's body and preferred measurement locations. The view of the camera element can be disturbed by the environmental conditions, such as a rescuer performing ventilations or CPR interposing between the camera element and the body measurement locations, or the illumination conditions, which could reduce drastically the signal to noise ratio.

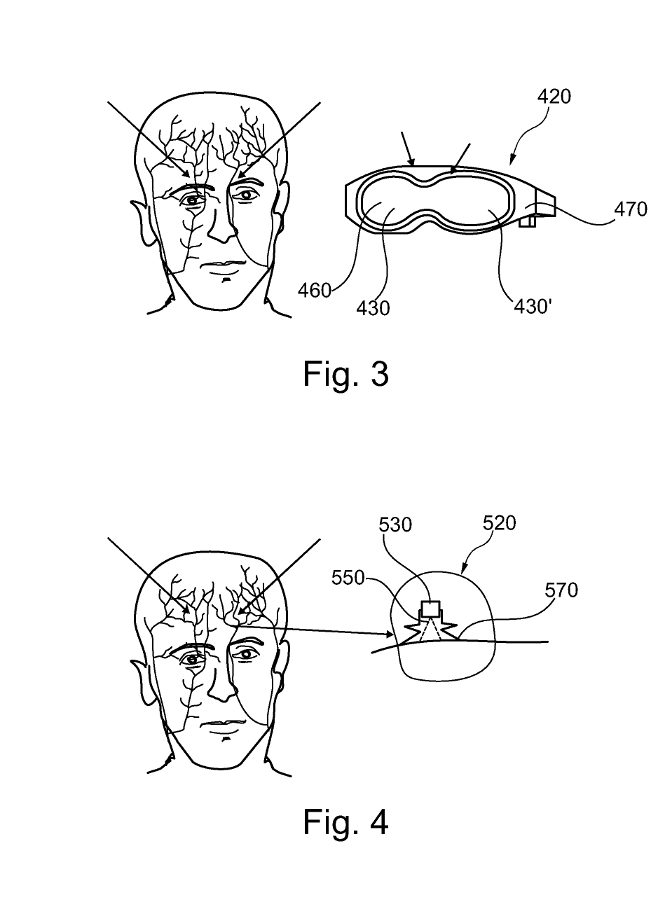

FIG. 3 discloses a sensor with a camera element adapted to be positioned closely to the patient's body.

The sensor 420 comprises a fixation element 470, for a firm fixation directly on the patient's body. The fixation element 470 of FIG. 3 comprises a goggle element, similar to a skiing or sport spectacle, and is adapted to be used as a spectacles on the body. The goggle type fixation element 470 provides for a firm fixation, without shifting, yet in the locations of interest around the eyes and the noise where relevant PGP signals can be measured.

Advantageously, at least one camera element 430 of the sensor 420 can be placed in the fixation element, in sufficiently close proximity of the arteries that need to be monitored but far enough to monitor the complete area of interest. The camera element 430 can be self aligned after placement.

The fixation element 470 is provided with a contact part that includes at least one camera opening 480, which aligns to the area of interest.

It is contemplated to use one camera element 430, but a second camera element 430′ may also be used. A two camera solution has advantages for mechanical stability and better suppression of motion artifacts and better determination of the common mode PPG signal.

The area of interest can be illuminated with a lamp 490, at the optimum light intensity and color. Optionally, the illumination can be with or without a stroboscopic type of illumination.

FIG. 4 discloses a sensor apparatus 520 with a camera element adapted to be positioned closely to the patient's body.

The camera element 520 comprises a fixation element 570, for a firm fixation directly on the patient's body. The fixation element 570 is adapted to be fixed on the forehead of the patient. The fixation element 570 comprises a suction cup, which advantageously may adapt to different morphologies and sizes of patients. A suction cup further is stable, without shifting, yet in the locations of interest where relevant PGP signals, such as the Nelcor PG and sPO2 sensor signal, can be measured.

The suction cup further provides shielding for external light. The camera element 530 is adapted to fit within the suction cup, together with a light source 550.

In summary, the present application discloses the use of a physiological sensor comprising at least one camera element adapted to cover a larger area, thereby providing a sensor that is less sensitive for motion than conventional PPG. The sensor can automatically detect and follow the “PPG hot spots” on for instance the face of the patient (or other relevant locations on the body).

By using established video processing and signal processing techniques (image location can be followed, motion is determined, other color can be used as reference signal, phase difference between flow and artifact signals) motion artifacts can be separated from the desired physiologic signal and the desired signal can be strengthened (e.g. by averaging over the measured area). Finally relatively low cost camera devices can be used (vga like, smart phone like, web cam like).

1. A physiological sensor for use with a Cardio Pulmonary Resuscitation (CPR) apparatus, the sensor comprising
at least one camera element, adapted to detect a physiological signal,
at least one illumination element, adapted to illuminate an area of a patient's body,
a housing, adapted to receive the at least one camera element and the at least one illumination element,
the housing comprising a fixation element for the fixation of the sensor either on an automated CPR apparatus or on the patient's body, and
An output element for supplying measured values of the physiological signal to a controller adapted to determine optimized parameters for CPR.

2. A physiological sensor according to claim 1, wherein the fixation element is a suction cup type element adapted to be placed on a patient's body.

3. A physiological sensor according to claim 1, wherein the fixation element is a goggle type element adapted to be placed on a patient's body.

4. A physiological sensor according to claim 1, wherein the fixation element is a band fixation type element adapted to be placed on a patient's body.

5. A physiological sensor according to claim 1, further comprising a shielding element for shielding from external light.

6. (canceled)

7. A physiological sensor according to claim 1, wherein the camera element is adapted to select an optimum location for the detection of the physiological signal.

8. A physiological sensor according to claim 7, wherein the camera element is adapted automatically segment area of the patient body, based on amplitude of the detected physiological signal and is further adapted to select a region with a strongest detected physiological signal.

9. A physiological sensor according to claim 1, the camera element being one of at least one of a monochrome, color or infra red camera element.

10. (canceled)

11. A physiological sensor according to claim 1, wherein the at least one camera element is adapted to measure photoplethysmography signals.

12. An automated Cardio Pulmonary Resuscitation apparatus, comprising
at least one sensor according to claim 1, supplying measured values of a physiological signal related to blood flow,
a controller, receiving the measured values from the at least one sensor, the controller being adapted to determine optimized operating parameters for the CPR.

13. An automated CPR according to claim 12, comprising
an indication element to indicate to a rescuer modifications to operating parameters related to the compression.

14. An automated CPR according to claim 12, comprising
a chest compression actuator,
an actuator driver that supplies drive signals to the chest compression actuator in dependence of operating parameters of the actuator driver, the operating parameters being received from the controller.
